(19) United States
(12) Patent Application Publication
(10) Pub. No.: US 2024/0142261 A1
(43) Pub. Date: May 2, 2024

(54) MAP INFORMATION OUTPUT APPARATUS AND MAP INFORMATION OUTPUT METHOD

(71) Applicant: Mitsubishi Electric Corporation, Tokyo (JP)

(72) Inventors: Michihiro OGATA, Tokyo (JP); Kazuo Hitosugi, Tokyo (JP)

(73) Assignee: Mitsubishi Electric Corporation, Tokyo (JP)

(21) Appl. No.: 18/357,524

(22) Filed: Jul. 24, 2023

(30) Foreign Application Priority Data
Oct. 28, 2022 (JP) 2022-172920

(51) Int. Cl. G01C 21/00

(52) U.S. Cl. CPC G01C 21/3819; G01C 21/3848; G01C 21/3885

(57) ABSTRACT

To provide a map information output apparatus and a map information output method which can reduce a time lag of the positional shift correction of the map information acquired corresponding to the position coordinate of the ego vehicle, when traveling the curve road. A map information output apparatus acquires map information corresponding to a position coordinate of an ego vehicle from map data; acquires a map road shape corresponding to a road where the ego vehicle is traveling; detects a detection road shape where the ego vehicle is traveling based on detection information of a periphery monitoring apparatus; and corrects position information of the map information with respect to a position of the ego vehicle, based on map curvature information which is curvature information included in the map road shape, and detection curvature information which is curvature information included in the detection road shape.

### INCORPORATION BY REFERENCE

The disclosure of Japanese Patent Application No. 2022-172920 filed on Oct. 28, 2022 including its specification, claims and drawings, is incorporated herein by reference in its entirety.

### BACKGROUND

The present disclosure relates to a map information output apparatus and a map information output method.

The technology for acquiring map information corresponding to the positioned position coordinate of the ego vehicle and controlling the ego vehicle based on the map information has been developed. If the position coordinate of the ego vehicle has an error, an error occurs in a distance at each point of the map information with respect to the position of the ego vehicle.

In JP 7037317 B, utilizing a Clothoid section on a route, a shifting width in the longitudinal direction of the position coordinate of the ego vehicle is calculated by comparing the curvature of the past traveling trajectory with the curvature of the road acquired from the map information; and a positional shift is corrected.

### SUMMARY

However, in the technology of JP 7037317 B, since the past traveling trajectory is used, a time lag occurs until the traveling trajectory is accumulated after the start of traveling in the Clothoid section where the curvature changes and the positional shift is detected. In the curve road like the Clothoid section, the vehicle control in accordance with the road shape is especially required. Accordingly, the time lag of the positional shift correction is desired to be reduced.

Then, the purpose of the present disclosure is to provide a map information output apparatus and a map information output method which can reduce a time lag of the positional shift correction of the map information acquired corresponding to the position coordinate of the ego vehicle, when traveling the curve road.

A map information output apparatus according to the present disclosure, including:
an ego vehicle state acquisition unit that acquires a position coordinate of an ego vehicle;
a map information acquisition unit that acquires map information corresponding to the position coordinate of the ego vehicle from map data, and acquires a map road shape which is a road shape corresponding to a road where the ego vehicle is traveling and which is included in the map information;
a periphery information acquisition unit that detects a detection road shape which is a road shape where the ego vehicle is traveling, based on detection information of a periphery monitoring apparatus which monitors periphery of the ego vehicle;
a map position correction unit that corrects position information of the map information with respect to a position of the ego vehicle, based on map curvature information which is curvature information included in the map road shape, and detection curvature information which is curvature information included in the detection road shape.

A map information output method according to the present disclosure, including:
an ego vehicle state acquisition step of acquiring a position coordinate of an ego vehicle;
a map information acquisition step of acquiring map information corresponding to the position coordinate of the ego vehicle from map data, and acquires a map road shape which is a road shape corresponding to a road where the ego vehicle is traveling and which is included in the map information;
a periphery information acquisition step of detecting a detection road shape which is a road shape where the ego vehicle is traveling, based on detection information of a periphery monitoring apparatus which monitors periphery of the ego vehicle; and
a map position correction step of correcting position information of the map information with respect to a position of the ego vehicle, based on map curvature information which is curvature information included in the map road shape, and detection curvature information which is curvature information included in the detection road shape.

According to the map information output apparatus and the map information output method of the present disclosure, based on the map curvature information acquired corresponding to the position coordinate of the ego vehicle, and the detection curvature information detected based on the detection information of the periphery monitoring apparatus, the position information of the map information with respect to the position of the ego vehicle can be corrected. At this time, since the detection curvature information detected based on the detection information of the periphery monitoring apparatus is used, the curvature information of the road where the ego vehicle is traveling can be detected, without waiting until the ego vehicle travels the curve road to some extent and the traveling trajectory is accumulated like JP 7037317 B. Accordingly, when traveling the curve road, a time lag of the positional shift correction of the map information acquired corresponding to the position coordinate of the ego vehicle can be reduced.

### BRIEF DESCRIPTION OF THE DRAWINGS

FIG. 1 is a schematic block diagram of the vehicle control apparatus and the map information output apparatus according to Embodiment 1;

FIG. 2 is a schematic hardware configuration diagram of the vehicle control apparatus according to Embodiment 1;

FIG. 3 is a schematic hardware configuration diagram of the vehicle control apparatus according to Embodiment 1;

FIG. 4 is a flowchart for explaining processing of the vehicle control apparatus and the map information output apparatus according to Embodiment 1;

FIG. 5 is a figure for explaining the ego vehicle coordinate system according to Embodiment 1;

FIG. 6 is a figure for explaining the approximate line of the lane marking according to Embodiment 1;

FIG. 7 is a figure when the map curvature monotonically increases in the determination road section according to Embodiment 1;

FIG. 8 is a figure when map curvature monotonically decreases in the determination road section according to Embodiment 1;

FIG. 9 is a figure for explaining the linear interpolation according to Embodiment 1; and

FIG. 10 is a figure for explaining position correction of the map information according to Embodiment 1.

### DETAILED DESCRIPTION OF THE EMBODIMENTS

### 1. Embodiment 1

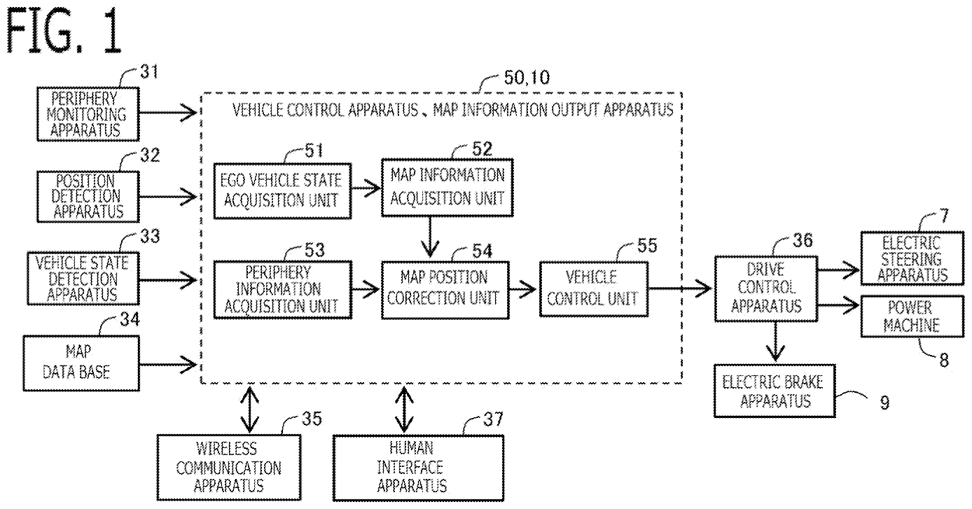

A map information output apparatus 10 and a map information output method according to Embodiment 1 will be explained with reference to drawings. FIG. 1 is a schematic block diagram of the map information output apparatus 10. In the present embodiment, the map information output apparatus 10 may be embedded into a vehicle control apparatus 50 which performs a control of an ego vehicle, such as an automatic driving.

As shown in FIG. 1, the ego vehicle is provided with a periphery monitoring apparatus 31, a position detection apparatus 32, a vehicle state detection apparatus 33, a map data base 34, a wireless communication apparatus 35, a vehicle control apparatus 50, a drive control apparatus 36, a power machine 8, an electric steering apparatus 7, an electric brake apparatus 9, a human interface apparatus 37, and the like.

The periphery monitoring apparatus 31 is an apparatus which monitors the periphery of the ego vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detecting apparatus 32 is an apparatus which detects a position coordinate of the ego vehicle. And, a GPS antenna which receives the signal outputted from satellites, such as GNSS (Global Navigation Satellite System), is used. The position coordinate is a latitude, a longitude, an altitude, and the like. For detection of the position coordinate of the ego vehicle, various kinds of methods, such as the method using the traveling lane identification number of the ego vehicle, the map matching method, the dead reckoning method, and the method using the detection information around the ego vehicle, may be used.

The map data base 34 stores map data. The map data includes road shape information (for example, a number of lanes, a shape of each lane, a type of each lane, a road type, curvature information, slope information, a branching or merging point, a road structure), and traffic regulations information (for example, a sign, a road signal, a regulation speed, prohibition of overtaking, prohibition of lane change). The road structure includes a tunnel, an elevated bridge, abridge, a multi-level crossing, and the like. The road shape information and the traffic regulations information are set at each point along the traveling direction of the road. The map data base 34 is mainly constituted of a storage apparatus. The map data base 34 may be provided in a server outside the vehicle connected to the network, and the vehicle control apparatus 50 may acquire required road information from the server outside the vehicle via the wireless communication apparatus 35.

As the drive control apparatus 36, a power controller, a brake controller, an automatic steering controller, a light controller, and the like are provided. The power controller controls an output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle condition detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Vehicle Control Apparatus 50

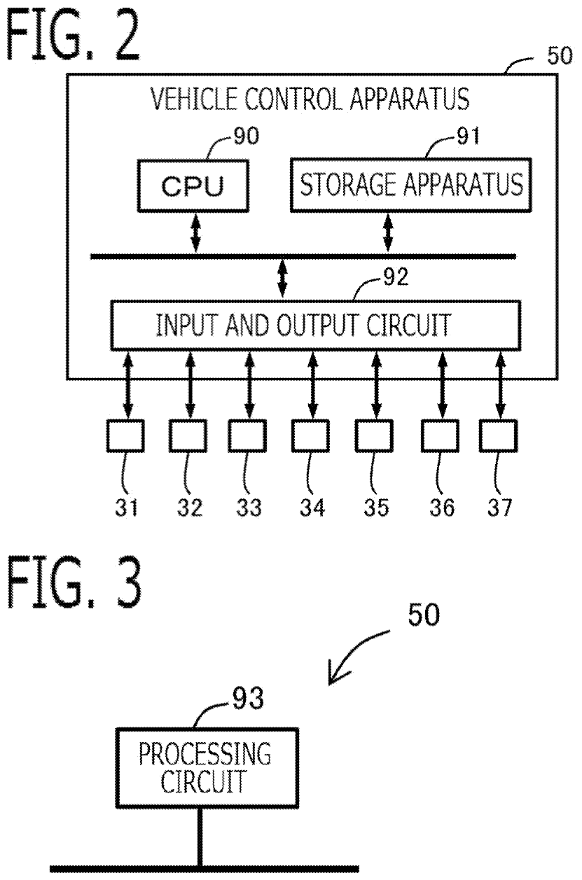

The vehicle control apparatus 50 is provided with functional units of an ego vehicle state acquisition unit 51, a map information acquisition unit 52, a periphery information acquisition unit 53, a map position correction unit 54, and a vehicle control unit 55 and the like. Each function of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map data base 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective functions of the functional units 51 to 55 provided in the vehicle control apparatus 50 are realized. Setting data, such as a determination distance, utilized in the functional units 51 to 55 are stored in the storage apparatus 91, such as EEPROM.

Alternatively, as shown in FIG. 3, the vehicle control apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 50 will be described in detail below.

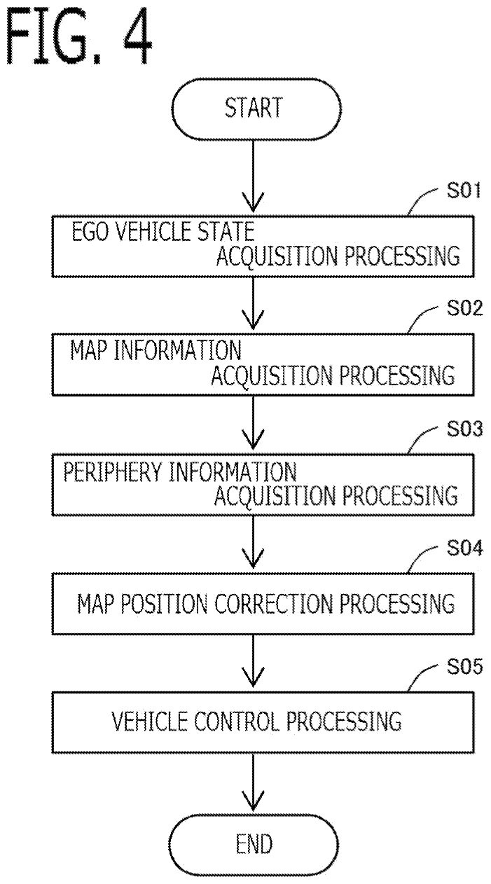

FIG. 4 is a schematic flowchart for explaining the procedure of processing of the vehicle control apparatus 50 (the map information output method) and the map information output apparatus 10 according to the present embodiment. The processing of the flowchart in FIG. 4 is recurrently executed every predetermined operation period by the arithmetic processor 90 executing software (a program) stored in the storage apparatus 91.

### 1-1. Ego Vehicle State Acquisition Unit 51

In the step S01 of FIG. 4, the ego vehicle state acquisition unit 51 executes an ego vehicle state acquisition processing (an ego vehicle state acquisition step) of acquiring a position coordinate of the ego vehicle. The ego vehicle state acquisition unit 51 acquires movement information of the ego vehicle.

The ego vehicle state acquisition unit 51 acquires the position coordinate of the ego vehicle, a moving direction, a speed, an acceleration, and the like, based on the position coordinate of the ego vehicle acquired from the position detection apparatus 32, and the ego vehicle state acquired from the vehicle state detection apparatus 33.

As mentioned above, as the position detection apparatus 32, a GNSS antenna and the like which receives GNSS (Global Navigation Satellite System) signals, such as GPS and QZSS, outputted from satellites is provided. The ego vehicle state acquisition unit 51 detects the position coordinate of the ego vehicle, based on the GNSS signals received by the GNSS antenna. The position coordinate is a latitude, a longitude, an altitude, and the like. When the GNSS signals cannot be detected, the ego vehicle state acquisition unit 51 may update the position coordinate, based on the detection information of the vehicle state detection apparatus 33.

The ego vehicle state acquisition unit 51 determines a reliability of the position coordinate of the ego vehicle. For example, the ego vehicle state acquisition unit 51 determines the reliability of the position coordinate of the ego vehicle, based on a radio field intensity of the position detection apparatus 32. The reliability becomes large as the radio field intensity becomes large.

### 1-2. Map Information Acquisition Unit 52

In the step S02 of FIG. 4, the map information acquisition unit 52 executes a map information acquisition processing (a map information acquisition step) of acquiring map information corresponding to the position coordinate of the ego vehicle from the map data, and acquiring a map road shape which is a road shape corresponding to a road where the ego vehicle is traveling and which is included in the map information. In the present embodiment, the map data is stored in the map data base 34.

The road shape includes the curvature information of each lane. In the present embodiment, the curvature information is a curvature, but it may be a curvature radius which is a reciprocal of the curvature.

The map information acquisition unit 52 acquires the map information around the ego vehicle from the map data, based on the position coordinate of the ego vehicle. The map information acquisition unit 52 determines a road (hereinafter, referred to as a traveling road) where the ego vehicle is traveling, based on the position coordinate of the ego vehicle, and acquires the curvature information of the traveling road (lane). At this time, the map information acquisition unit 52 acquires the map curvature information which is curvature information at each point of the traveling road along the traveling direction of the traveling road on the basis of the road point corresponding to the position coordinate of the ego vehicle. In the present embodiment, the map information acquisition unit 52 acquires a distance Lmp from the road point of the ego vehicle to each point of the traveling road, along the traveling direction of the traveling road, and the map curvature information at each point. In the present embodiment, as the map curvature information, a curvature Crvmp (hereinafter, referred to as a map curvature Crvmp) is acquired.

### 1-3. Periphery Information Acquisition Unit 53

In the step S03 of FIG. 4, the periphery information acquisition unit 53 executes a periphery information acquisition processing (a periphery information acquisition step) of detecting a detection road shape which is a road shape where the ego vehicle is traveling, based on the detection information of the periphery monitoring apparatus 31 which monitors the periphery of the ego vehicle.

In the present embodiment, the periphery information acquisition unit 53 detects, as the detection road shape, a shape of lane marking of the road where the ego vehicle is traveling, based on the detection information of the camera as the periphery monitoring apparatus 31.

The camera includes the camera which monitors the front of the ego vehicle. Various kinds of well-known image processing is performed to a picture imaged by the camera, and the lane marking of road is recognized. Although the lane marking is mainly a white line, it is not limited to the white line, and a roadside object, such as a guardrail, a pole, a road shoulder, and a wall, may be recognized as the lane marking. As the periphery monitoring apparatus 31, the laser radar may be used, and the white line may be recognized from points where reflection luminance of the laser radar is high.

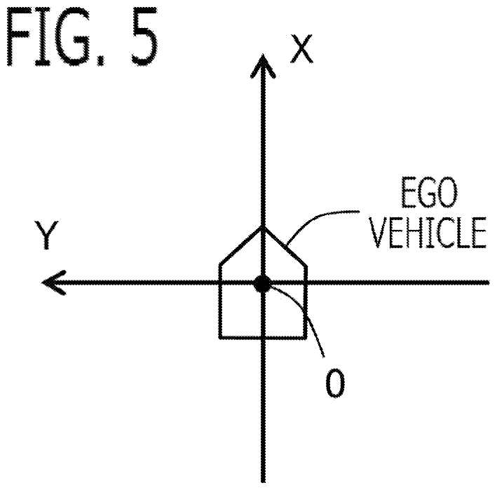

The periphery information acquisition unit 53 detects the shape of each recognized lane marking in an ego vehicle coordinate system. As shown in FIG. 5, the ego vehicle coordinate system is a coordinate system which has two axes of a longitudinal direction X and a lateral direction Y of the ego vehicle. The origin of the ego vehicle coordinate system is set at a center of the ego vehicle, such as a neutral steer point.

In the present embodiment, the periphery information acquisition unit 53 detects the curvature information of the road where the ego vehicle is traveling (hereinafter, referred to as detection curvature information), as the detection road shape where the ego vehicle is traveling. In the present embodiment, the periphery information acquisition unit 53 detects a coefficient of curvature K2 which is a coefficient of a second-order term when approximating the lane marking by a polynomial of the equation (1), as the detection curvature information. Since the equation (1) is an equation of the position of the Y direction with respect to the distance of the X direction, the equation (1-1) which is a curvature equation of lane marking is obtained by performing a second-order differentiation to the equation (1) by the distance X (expressed by (d²y/dx²)=Y″(X)). At this time, the curvature information Crvdt at the longitudinal direction of the ego vehicle X=0, that is, at the position of the ego vehicle becomes Y″(0)=K2. That is to say, the periphery information acquisition unit 53 calculates the coefficient of curvature K2 as the detection curvature Crvdt as it is.

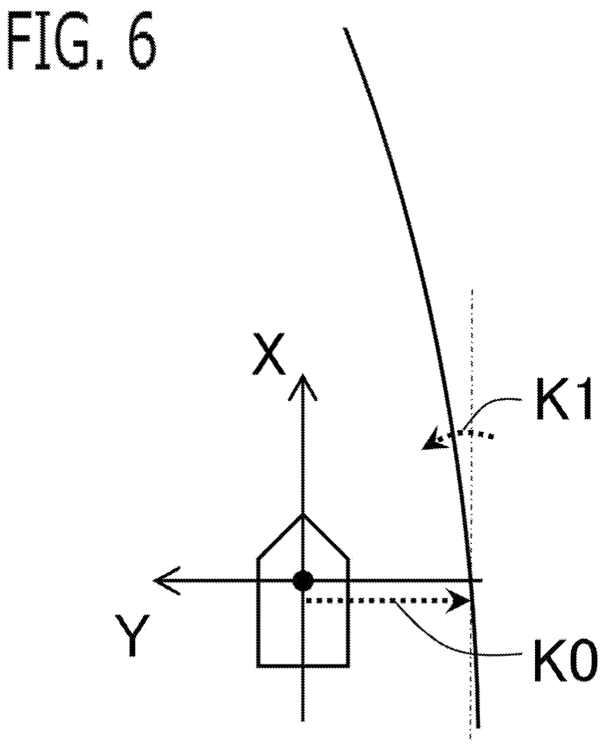

In the present embodiment, as shown in FIG. 6, the periphery information acquisition unit 53 further detects, as the shape of each lane marking, a lane marking distance K0 which is a distance between the ego vehicle and a part of the lane marking located in the lateral direction Y of the ego vehicle, a lane marking angle K1 which is an inclination of the part of the lane marking located in the lateral direction Y of the ego vehicle with respect to the longitudinal direction X of the ego vehicle, and a curvature change rate of lane marking K3 in the longitudinal direction X of the ego vehicle. Using these parameters K0 to K3 of the lane marking information, the position of the lane marking in the ego vehicle coordinate system can be calculated by the next equation. That is to say, each lane marking is approximated by an approximation equation expressed by a third-order polynomial in which the position Y in the lateral direction and the position X in the longitudinal direction of the lane marking in the ego vehicle coordinate system are set as variables. Each order coefficient is acquired as the parameters K0 to K3 indicating the lane marking information. As shown in the equation (1-1), the curvature of the lane marking at the position X in the longitudinal direction of the ego vehicle becomes K2+K3×X. It may be approximated by a second-order polynomial which does not have the third-order term of the curvature change rate K3.

$$Y = K 0 + K 1 \times X + \frac{1}{2} \times K 2 \times {X}^{2} + \frac{1}{6} \times K 3 \times {X}^{3} \qquad ( 1 )$$

$$\frac{{d}^{2} Y}{d {x}^{2}} = {Y}^{″} ( X ) = K 2 + K 3 \times X \qquad ( 1 - 1 )$$

When the curvature of the lane marking on the left side and the curvature of the lane marking on the right side of the ego lane are detected, the periphery information acquisition unit 53 calculates an average value of the curvature on the left side and the curvature on the right side, or the curvature having higher detection reliability among the division line on the left side and the division line on the right side, as the curvature of the lane marking of the ego lane. The detection reliability of lane marking is determined based on a detection distance, a variation (variance) in the detection result, a detection duration, a matching degree with road information included in the map information, and the like. The curvature of lane marking may be calculated by well-known methods other than the approximation equation of the equation (1).

The periphery information acquisition unit 53 determines a reliability of the detected detection road shape. For example, the periphery information acquisition unit 53 determines the reliability of the detection road shape, based on a matching degree between the original lane marking detected by the periphery monitoring apparatus 31 and the approximated curve. The periphery information acquisition unit 53 may determine the reliability of the detection road shape, based on a recognition probability of the original lane marking detected by the periphery monitoring apparatus 31.

### 1-4. Map Position Correction Unit 54

In the step S04 of FIG. 4, the map position correction unit 54 executes a map position correction processing (a map position correction step) of correcting position information of the map information with respect to a position of the ego vehicle, based on map curvature information which is curvature information included in the map road shape, and detection curvature information which is curvature information included in the detection road shape.

According to this configuration, based on the map curvature information acquired corresponding to the position coordinate of the ego vehicle, and the detection curvature information detected based on the detection information of the periphery monitoring apparatus 31, the position information of the map information with respect to the position of the ego vehicle can be corrected. At this time, since the detection curvature information detected based on the detection information of the periphery monitoring apparatus 31 is used, the curvature information of the road where the ego vehicle is traveling can be detected, without waiting until the ego vehicle travels the curve road to some extent and the traveling trajectory is accumulated like JP 7037317 B. Accordingly, when traveling the curve road, a time lag of the positional shift correction of the map information acquired corresponding to the position coordinate of the ego vehicle can be reduced.

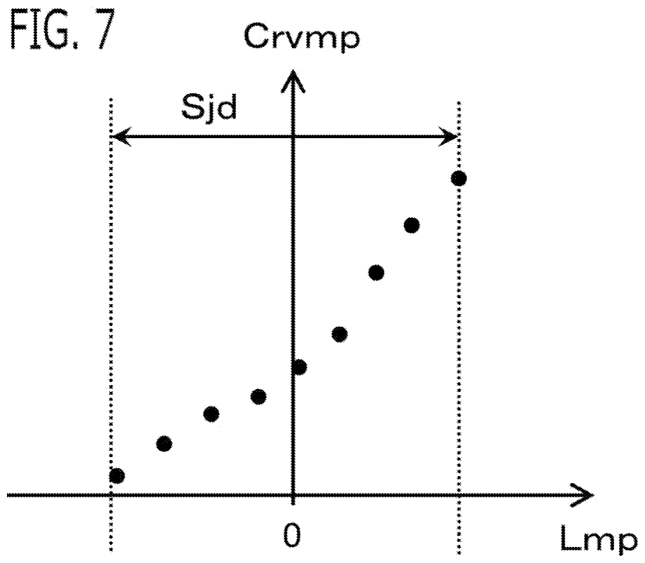

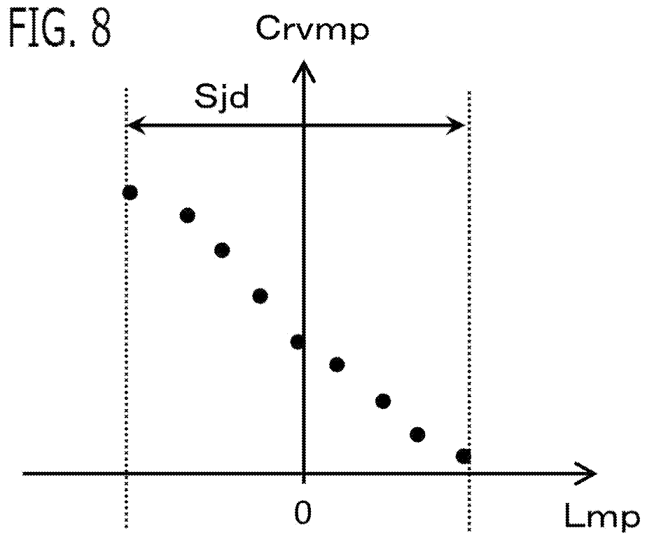

In the present embodiment, as shown in FIG. 7 and FIG. 8, the map position correction unit 54 determines whether or not a map curvature Crvmp which is a curvature included in the map curvature information monotonically increases or monotonically decreases with respect to a traveling direction of road, in a determination road section Sjd including a road point corresponding to the position coordinate of the ego vehicle. FIG. 7 shows an example of the monotonic increase, and FIG. 8 shows an example of the monotonic decrease. Herein, the monotonic increase and the monotonic decrease are the strictly monotonic increase and the strictly monotonic decrease which do not include the equal sign.

The determination road section Sjd is set to a section of the traveling road with a determination distance including the point of the traveling road corresponding to the position coordinate of the ego vehicle. FIG. 7 and FIG. 8 show a distance Lmp at each point and the map curvature Crvmp at each point of the traveling road from the road point corresponding to the position coordinate of the ego vehicle along the traveling direction of the traveling road. In the present embodiment, the determination road section Sjd is set longitudinal-symmetrically centering on the road point corresponding to the position coordinate of the ego vehicle. The determination road section Sjd may not be set longitudinal-symmetrically.

When there is no position coordinate of the ego vehicle on the traveling road determined that the ego vehicle is traveling, a point of the traveling road closest to the position coordinate of the ego vehicle is determined as a point of the traveling road corresponding to the position coordinate of the ego vehicle, for example. When the position coordinate of the ego vehicle is on the traveling road, the position coordinate of the ego vehicle is determined as a point of the traveling road corresponding to the position coordinate of the ego vehicle.

In the present embodiment, the map position correction unit 54 changes a length (a determination distance) of the determination road section Sjd, based on the reliability of the position coordinate of the ego vehicle. Specifically, the map position correction unit 54 lengthens the determination distance as the reliability of the position coordinate of the ego vehicle becomes low. According to this configuration, a range where the position correction is performed can be set appropriately, according to the reliability of the position coordinate of the ego vehicle.

Then, when the map curvature Crvmp becomes the monotonic increase or the monotonic decrease in the determination road section Sjd, the map position correction unit 54 calculates a position error ΔLmperr for correcting the position information of the map information, based on the map curvatures Crvmp at a plurality of points in the determination road section Sjd, and the detection curvature Crvdt which is the curvature at the position of the ego vehicle included in the detection curvature information.

According to this configuration, when the map curvature Crvmp monotonically increases or monotonically decreases in the determination road section Sjd, since the point of the map curvature Crvmp corresponding to the detection curvature Crvdt can be determined uniquely, the position error ΔLmperr for correcting the position information can be calculated with good accuracy.

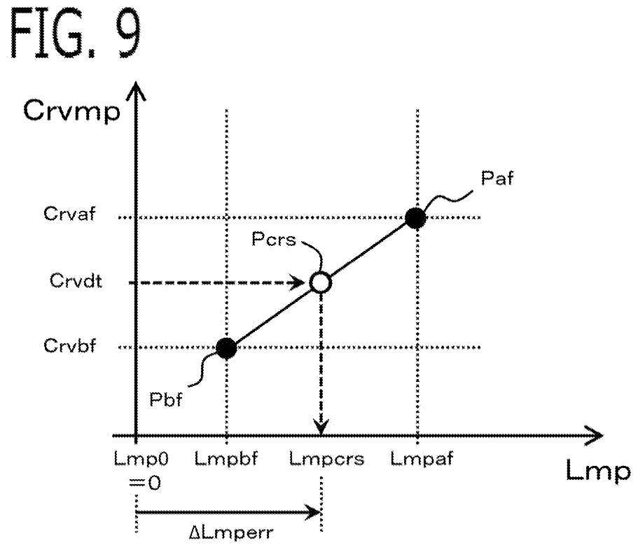

In the present embodiment, as shown in FIG. 9, the map position correction unit 54 determines two points Pbf, Paf before and after the map curvatures Crvmp at the plurality of points in the determination road section Sjd cross the detection curvature Crvdt along the traveling direction of road; and calculates the position error ΔLmperr, based on positions Lmpbf, Lmpaf of the two points Pbf, Paf before and after crossing with respect to a position Lmp0 of the road point corresponding to the position coordinate of the ego vehicle.

In the present embodiment, as the position Lmp0, Lmpbf, Lmpaf at each point of the traveling road, a distance Lmp at each point of the traveling road from the road point corresponding to the position coordinate of the ego vehicle along the traveling direction of the traveling road is used. As the position error ΔLmperr, an error of the distance along the traveling direction of the traveling road is used.

Based on the positions Lmpbf, Lmpaf of the two points Pbf, Paf before and after the map curvatures Crvmp at the plurality of points cross the detection curvature Crvdt, the position error ΔLmperr can be calculated with good accuracy.

For example, as shown in FIG. 9, the map position correction unit 54 calculates a position Lmpcrs corresponding to a crossing point Pcrs where a line which connects the map curvatures Crvbf, Crvaf at the two points Pbf, Paf before and after crossing cross the detection curvature Crvdt, based on the map curvatures Crvbf, Crvaf and the positions Lmpbf, Lmpaf at the two points Pbf, Paf before and after crossing, and the detection curvature Crvdt; and calculates a position deviation (in this example, a distance deviation) of the position Lmpcrs at the crossing point with respect to the position Lmp0 of the road point corresponding to the position coordinate of the ego vehicle, as the position error ΔLmperr.

Using the next equation for performing a linear interpolation, the map position correction unit 54 calculates the intersectional position Lmpcrs, based on the map curvature Crvbf at the point Pbf before crossing, the map curvature Crvaf at the point Paf after crossing, the position Lmpbf at the point Pbf before crossing, the position Lmpaf at the point Paf after crossing, and the detection curvature Crvdt. Since the position Lmp0 at the road point corresponding to the position coordinate of the ego vehicle is 0, the map position correction unit 54 calculates the intersectional position Lmpcrs as the position error ΔLmperr.

$${Lmp}_{crs} = {Lmp}_{bf} + \frac{( {Lmp}_{af} - {Lmp}_{bf} )}{( {Crv}_{af} - {Crv}_{bf} )} ( {Crv}_{dt} - {Crv}_{bf} ) \qquad ( 2 )$$

According to this configuration, by interpolating linearly with the detection curvature Crvdt between the map curvatures Crvbf, Crvaf at the two points before and after crossing, the position Lmpcrs at the crossing point and the position error ΔLmperr can be calculated with good accuracy.

In the present embodiment, only when the reliability of the position coordinate of the ego vehicle is higher than or equal to a threshold value and the reliability of the detection road shape is higher than or equal to a threshold value, the map position correction unit 54 calculates the position error ΔLmperr for correcting the position information of the map information.

When the reliability of the position coordinate of the ego vehicle is less than the threshold value, or when the reliability of the detection road shape is less than the threshold value, the map position correction unit 54 does not calculate the position error ΔLmperr. In this case, the position error ΔLmperr calculated when the reliability was high may be kept, and the correction of the position information of the map information may be performed. Or, the correction of the position information of the map information may not be performed.

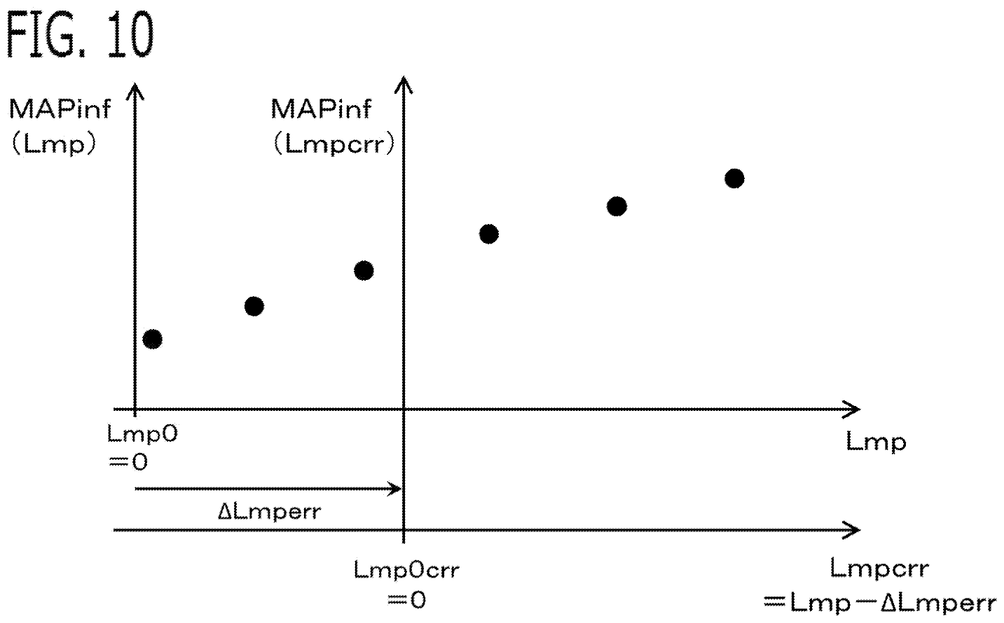

Then, the map position correction unit 54 corrects the position information of the map information with respect to the position of the ego vehicle, by the position error ΔLmperr. In the present embodiment, as shown in FIG. 10, the map position correction unit 54 moves the position Lmp0 at the road point corresponding to the position coordinate of the ego vehicle by the position error Δ Lmperr along the traveling direction of the traveling road, and calculates a position Lmp0crr after correction at the road point corresponding to the position coordinate of the ego vehicle; and corrects the position information of the map information with respect to the position of the ego vehicle so that the ego vehicle locates at the position Lmp0crr after correction at the road point.

For example, as shown in FIG. 10 and the next equation, the map position correction unit 54 corrects the distance Lmp before correction at each point of the traveling road along the traveling direction of the traveling road, by the position error ΔLmperr (in this example, subtraction), and calculates the distance Lmpcrr after correction at each point. Then, the map position correction unit 54 makes the map information MAPinf of the distance Lmp before correction at each point correspond to the distance Lmpcrr after correction at each point.

Lmp_{crr}=Lmp−ΔLmperr (3)

MAPinf(Lmp_{crr})=MAPinf(Lmp)

As the map information MAPinf whose position information is corrected, the map information correlated with the distance Lmp from the road point corresponding to the position coordinate of the ego vehicle along the traveling direction of the traveling road is set. For example, the map position correction unit 54 corrects at least one or more of a distance at each point of the map road shape, a distance at each point of traffic regulations information, and a distance at each point of traveling route information where the ego vehicle travels, by the position error ΔLmperr. As mentioned above, the map road shape includes the map curvature, the road slope, the lane width, the number of lanes, the branching or merging point, the road structure, and the like at each point along the traveling direction of the traveling road. The traffic regulations information includes the sign, the signal, the regulation speed, and the like at each point along the traveling direction of the traveling road. The target travel route includes the target traveling lane, the lane change position, the target speed, the target acceleration, and the like at each point along the traveling direction of the traveling road.

Alternatively, the map position correction unit 54 may calculate a deviation between the position coordinate of the position Lmp0 at the road point corresponding to the position coordinate of the ego vehicle, and the position coordinate of the position Lmp0crr after correction at the road point corresponding to the position coordinate of the ego vehicle, as an error of position coordinate; and may correct the position information of the map information by the error of position coordinate.

### 1-5. Vehicle Control Unit 55

In the step S05 of FIG. 4, the vehicle control unit 55 executes a vehicle control processing (a vehicle control step) of controlling traveling of the ego vehicle, based on the map information whose position information was corrected. For example, various kinds of map information corresponding to the distance Lmpcrr after correction at each point of the traveling road along the traveling direction of the traveling road is used.

When performing an automatic driving, the vehicle control unit 55 determines a target traveling trajectory adjusted to the map information whose position information was corrected. At this time, the peripheral vehicle, the obstacle, the pedestrian, and the road shape which were acquired by the periphery information acquisition unit 53 are considered. The target traveling trajectory is a time series traveling plan of the position of the ego vehicle, the traveling direction of the ego vehicle, the speed of the ego vehicle, the driving lane, the position where lane is change, and the like at each future time.

The vehicle control unit 55 controls the vehicle so as to follow the target traveling trajectory of the ego vehicle. For example, the vehicle control unit 55 decides a target speed, a target steering angle, an operation command of the direction indicator, and the like. Each decided command value is transmitted to the drive control apparatus 36, such as the power controller, the brake controller, the automatic steering controller, and the light controller.

The power controller controls output of the power machine 8, such as the internal combustion engine and the motor, so that the speed of the ego vehicle follows the target speed. The brake controller controls the brake operation of the electric brake apparatus 9 so that the speed of the ego vehicle follows the target speed. The automatic steering controller controls the electric steering apparatus 7 so that the steering angle follows the target steering angle. The light controller controls the direction indicator according to the operation command of the direction indicator.

Alternatively, when performing a driving assistance of the driver, the vehicle control unit 55 transmits commands for performing the driving assistance of the driver to any one or more of the power controller, the brake controller, and the automatic steering controller, based on the map information whose position information was corrected; and controls any one or more of the output of the power machine 8, the brake operation of the electric brake apparatus 9, and the steering operation of the electric steering apparatus 7.

Alternatively, when performing a manual driving by the driver, the vehicle control unit 55 informs various kinds of guidance for driving to the driver via the human interface apparatus 37, based on the map information whose position information was corrected.

### Summary of Aspects of the Present Disclosure

Hereinafter, the aspects of the present disclosure is summarized as appendixes.
(Appendix 1) A map information output apparatus comprising:
   an ego vehicle state acquisition unit that acquires a position coordinate of an ego vehicle;
   a map information acquisition unit that acquires map information corresponding to the position coordinate of the ego vehicle from map data, and acquires a map road shape which is a road shape corresponding to a road where the ego vehicle is traveling and which is included in the map information;
   a periphery information acquisition unit that detects a detection road shape which is a road shape where the ego vehicle is traveling, based on detection information of a periphery monitoring apparatus which monitors periphery of the ego vehicle;
   a map position correction unit that corrects position information of the map information with respect to a position of the ego vehicle, based on map curvature information which is curvature information included in the map road shape, and detection curvature information which is curvature information included in the detection road shape.
(Appendix 2) The map information output apparatus according to appendix 1,
   wherein the map position correction unit determines whether or not a map curvature which is a curvature included in the map curvature information monotonically increases or monotonically decreases with respect to a traveling direction of road, in a determination road section including a road point corresponding to the position coordinate of the ego vehicle; and
   when determining that the map curvature monotonically increases or monotonically decreases, calculates a position error for correcting the position information of the map information, based on the map curvatures of a plurality of points in the determination road section, and a detection curvature which is a curvature at the position of the ego vehicle included in the detection curvature information.
(Appendix 3) The map information output apparatus according to appendix 2,
   wherein the map position correction unit changes a length of the determination road section, based on a reliability of the position coordinate of the ego vehicle.
(Appendix 4) The map information output apparatus according to appendix 2 or 3,
   wherein the map position correction unit determines two points before and after the map curvatures of the plurality of points in the determination road section cross the detection curvature along the traveling direction of road; and
   calculates the position error, based on positions of the two points before and after crossing with respect to a position of the road point corresponding to the position coordinate of the ego vehicle.
(Appendix 5) The map information output apparatus according to appendix 4,
   wherein the map position correction unit calculates a position corresponding to a crossing point where a line which connects the map curvatures of the two points before and after crossing crosses the detection curvature, based on the map curvatures and the positions of the two points before and after crossing, and the detection curvature; and
   calculates a position deviation of a position at the crossing point with respect to the position of the road point corresponding to the position coordinate of the ego vehicle, as the position error.
(Appendix 6) The map information output apparatus according to appendix 4 or 5,
   wherein the map position correction unit uses, as the position at each point, a distance at each point from a road point corresponding to the position coordinate of the ego vehicle along a traveling direction of a traveling road which is a road where the ego vehicle is traveling;
   uses, as the position error, an error of distance along the traveling direction of the traveling road;
   corrects a distance before correction at each point of the traveling road along the traveling direction of the traveling road, by the position error, to calculate a distance after correction at each point; and
   makes the map information corresponding to the distance before correction at each point correspond to the distance after correction at each point.
(Appendix 7) The map information output apparatus according to appendix 6,
   wherein the map position correction unit corrects at least one or more of a distance at each point of the map road shape, a distance at each point of traffic regulations information, and a distance at each point of traveling route information where the ego vehicle travels, by the position error.
(Appendix 8) The map information output apparatus according to any one of appendixes 1 to 7,
   wherein the periphery information acquisition unit detects, as the detection road shape, a shape of lane marking of the road where the ego vehicle is traveling, based on detection information of a camera as the periphery monitoring apparatus.
(Appendix 9) The map information output apparatus according to any one of appendixes 1 to 8,
   wherein, only when a reliability of the position coordinate of the ego vehicle is higher than or equal to a threshold value and a reliability of the detection road shape is higher than or equal to a threshold value, the map position correction unit calculates a position error for correcting the position information of the map information.
(Appendix 10) A map information output method comprising:
   an ego vehicle state acquisition step of acquiring a position coordinate of an ego vehicle;
   a map information acquisition step of acquiring map information corresponding to the position coordinate of the ego vehicle from map data, and acquires a map road shape which is a road shape corresponding to a road where the ego vehicle is traveling and which is included in the map information;
   a periphery information acquisition step of detecting a detection road shape which is a road shape where the ego vehicle is traveling, based on detection information of a periphery monitoring apparatus which monitors periphery of the ego vehicle; and
   a map position correction step of correcting position information of the map information with respect to a position of the ego vehicle, based on map curvature information which is curvature information included in the map road shape, and detection curvature information which is curvature information included in the detection road shape.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components may be modified, added, or eliminated.

What is claimed is:

1. A map information output apparatus comprising at least one processor configured to implement:
an ego vehicle state acquisitor that acquires a position coordinate of an ego vehicle;
a map information acquisitor that acquires map information corresponding to the position coordinate of the ego vehicle from map data, and acquires a map road shape which is a road shape corresponding to a road where the ego vehicle is traveling and which is included in the map information;
a periphery information acquisitor that detects a detection road shape which is a road shape where the ego vehicle is traveling, based on detection information of a periphery monitoring apparatus which monitors periphery of the ego vehicle;
a map position corrector that corrects position information of the map information with respect to a position of the ego vehicle, based on map curvature information which is curvature information included in the map road shape, and detection curvature information which is curvature information included in the detection road shape.

2. The map information output apparatus according to claim 1,
wherein the map position corrector determines whether or not a map curvature which is a curvature included in the map curvature information monotonically increases or monotonically decreases with respect to a traveling direction of road, in a determination road section including a road point corresponding to the position coordinate of the ego vehicle; and
when determining that the map curvature monotonically increases or monotonically decreases, calculates a position error for correcting the position information of the map information, based on the map curvatures of a plurality of points in the determination road section, and a detection curvature which is a curvature at the position of the ego vehicle included in the detection curvature information.

3. The map information output apparatus according to claim 2,
wherein the map position corrector changes a length of the determination road section, based on a reliability of the position coordinate of the ego vehicle.

4. The map information output apparatus according to claim 2,
wherein the map position corrector determines two points before and after the map curvatures of the plurality of points in the determination road section cross the detection curvature along the traveling direction of road; and
calculates the position error, based on positions of the two points before and after crossing with respect to a position of the road point corresponding to the position coordinate of the ego vehicle.

5. The map information output apparatus according to claim 4,
wherein the map position corrector calculates a position corresponding to a crossing point where a line which connects the map curvatures of the two points before and after crossing crosses the detection curvature, based on the map curvatures and the positions of the two points before and after crossing, and the detection curvature; and
calculates a position deviation of a position at the crossing point with respect to the position of the road point corresponding to the position coordinate of the ego vehicle, as the position error.

6. The map information output apparatus according to claim 4,
wherein the map position corrector uses, as the position at each point, a distance at each point from a road point corresponding to the position coordinate of the ego vehicle along a traveling direction of a traveling road which is a road where the ego vehicle is traveling;
uses, as the position error, an error of distance along the traveling direction of the traveling road;
corrects a distance before correction at each point of the traveling road along the traveling direction of the traveling road, by the position error, to calculate a distance after correction at each point; and
makes the map information corresponding to the distance before correction at each point correspond to the distance after correction at each point.

7. The map information output apparatus according to claim 6,
wherein the map position corrector corrects at least one or more of a distance at each point of the map road shape, a distance at each point of traffic regulations information, and a distance at each point of traveling route information where the ego vehicle travels, by the position error.

8. The map information output apparatus according to claim 1,
wherein the periphery information acquisitor detects, as the detection road shape, a shape of lane marking of the road where the ego vehicle is traveling, based on detection information of a camera as the periphery monitoring apparatus.

9. The map information output apparatus according to claim 1,
wherein, only when a reliability of the position coordinate of the ego vehicle is higher than or equal to a threshold value and a reliability of the detection road shape is higher than or equal to a threshold value, the map position corrector calculates a position error for correcting the position information of the map information.

10. A map information output method comprising:
acquiring a position coordinate of an ego vehicle;
acquiring map information corresponding to the position coordinate of the ego vehicle from map data, and acquires a map road shape which is a road shape corresponding to a road where the ego vehicle is traveling and which is included in the map information;
detecting a detection road shape which is a road shape where the ego vehicle is traveling, based on detection information of a periphery monitoring apparatus which monitors periphery of the ego vehicle; and
correcting position information of the map information with respect to a position of the ego vehicle, based on map curvature information which is curvature information included in the map road shape, and detection curvature information which is curvature information included in the detection road shape.
